(19) United States
(12) Patent Application Publication
(10) Pub. No.: US 2010/0051599 A1
(43) Pub. Date: Mar. 4, 2010

(54) GOLF BALL WARMER AND CARRYING CASE

(76) Inventor: Louis DeNitto, Gaithersburg, MD (US)

Correspondence Address: DONALD W. MEEKER, 924 EAST OCEAN FRONT, # E, NEWPORT BEACH, CA, 92661, US

(21) Appl. No.: 12/200,760

(22) Filed: Aug. 28, 2008

(51) Int. Cl. H05B 3/02; B65D 33/16; B65D 30/02; H05B 3/34

(52) U.S. Cl. 219/386; 383/63; 383/110; 219/529

(57) ABSTRACT

An insulated bag uses heating elements to heat golf balls contained in an insulated compartment. Another compartment contains a small battery pack to power the heating elements.

### CROSS-REFERENCE TO RELATED APPLICATIONS

The present utility patent application claims the benefit of provisional application No. 60/916,735, filed May 8, 2007.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to golf ball preparation for play and in particular to a device for heating golf balls to a desired temperature for play using heating elements powered by a battery pack in an insulated bag containing the golf balls to warm the balls, so that the golfer can hit the heated golf balls much further than hitting cold golf balls.

2. Description of Related Art Including Information Disclosed Under 37 CFR 1.97 and 1.98

Outside temperatures have an effect on golf balls. Golf balls with high compression lose this advantage when the temperature is cold and when hit by a golfer can feel like hitting a rock because of its density mixed with the cold weather. Testing results show that golf balls heated to an internal temperature of between 100° to 120° will provide much longer driving distances compared with balls measured at lower temperatures.

The prior art fails to provide a convenient easy to use and easy to carry means for heating a number of golf balls while transporting the golf balls and using the golf balls on the course.

What is needed is a convenient easy to use and easy to transport insulated baf having heating coils powered by a battery for heating a number of golf balls while transporting the golf balls for using the heated golf balls on the course.

### BRIEF SUMMARY OF THE INVENTION

The objective of the present invention is to provide an insulated case that is easy to use and easy to transport and that heats golf balls using a rechargeable battery pack. Preferably four golf balls are placed in the heated and insulated bag and are numbered so that they can be rotated. Therefore, the warmest ball is removed first. This allows the cooler golf balls time to be heated inside the bag.

In brief, the present invention is an insulated bag with two compartments; one inside compartment that holds and warms preferably four golf balls, and one outside compartment that is not insulated and holds a battery pack. The inside compartment is insulated and has heating elements in the walls which are connected to the battery pack that is located in the outside compartment. This battery pack is removable and rechargeable and provides power to the heating elements for approximately 5 hours while maintaining a desired temperature so that the golf balls stay warm even when the outside temperature is cold. After the battery pack heats golf balls for up to five hours, it is then recharged using the charger in a standard outlet.

The golf ball warmer of the present invention heats golf balls so they can travel further than unheated cold golf balls when struck with a golf club.

### BRIEF DESCRIPTION OF THE SEVERAL VIEWS OF THE DRAWINGS

These and other details of the present invention will be described in connection with the accompanying drawings, which are furnished only by way of illustration and not in limitation of the invention, and in which drawings:

FIG. 1 is a perspective view of the golf ball carrying and warming container of the present invention showing the contained golf balls, battery and heating elements in dashed lines;

FIG. 2 is a perspective view of the golf ball carrying and warming container of FIG. 1 with the two compartments open showing the golf balls in the heated compartment and the battery pack in an outer compartment;

FIG. 3 is a cross-sectional view taken through a vertical transverse centerline of the golf ball carrying and warming container of FIG. 1 showing the golf balls, battery, heating elements, and insulation;

FIG. 4 is a perspective view of the components of the golf ball carrying and warming device of FIG. 1 showing the battery pack removed from the outer compartment and showing a plug for connecting the battery pack to the heater elements.

### DETAILED DESCRIPTION OF THE INVENTION

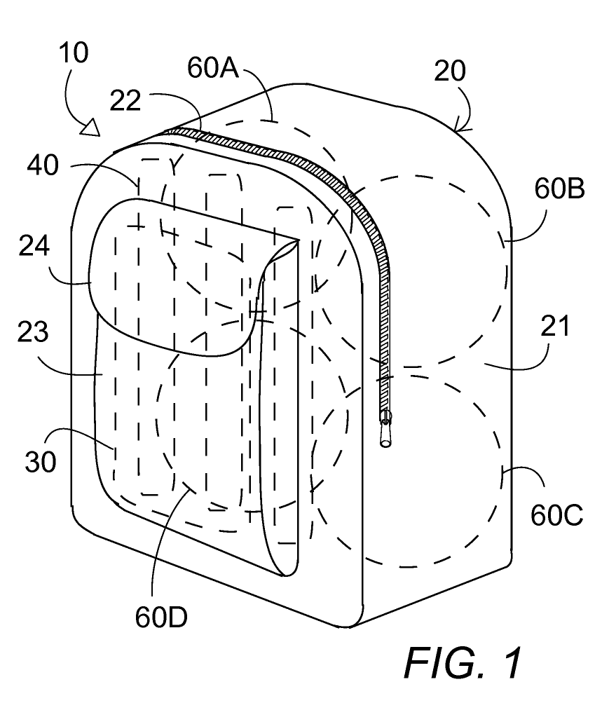

In FIGS. 1-4, an insulated heated container device 10 for warming golf balls 60 and 60A-60D comprises a carrying case 20 or bag comprising an insulated heated golf ball carrying compartment 21 and an outer compartment 23 housing a battery 30 for powering heating coils 40, the outer compartment 23 located in proximity to the inner compartment 21. A flap having a mating hook and loop fastener opens and closes the outer compartment 23 so that the battery pack is secured. The battery pack 30 powers the heating elements 40. An electrical plug 41 and wires transfer the power from the battery pack to the heating elements.

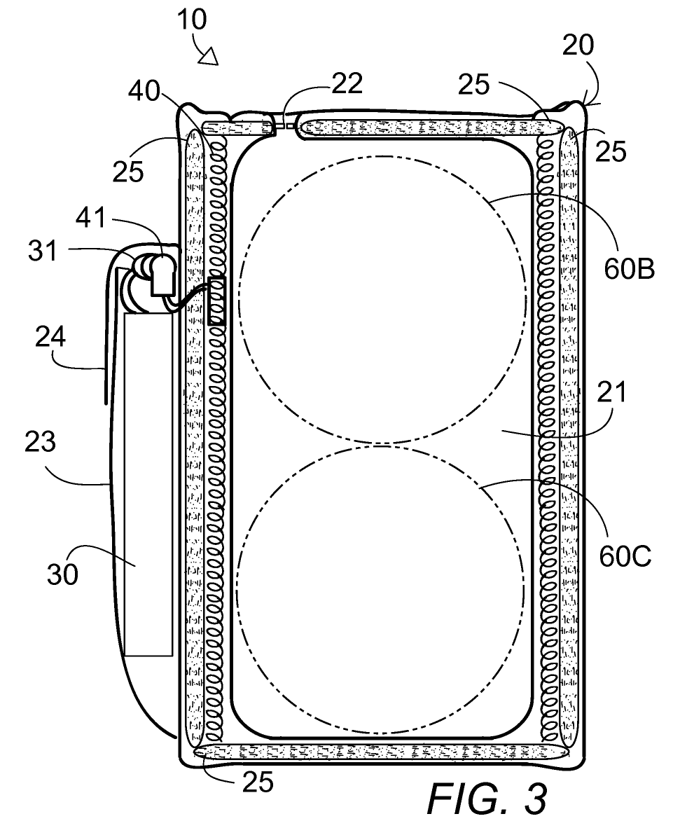

In FIGS. 1-3, the inner first compartment 21 is sufficiently large for containing a plurality of golf balls 60A 60D therein and comprises thermally insulated walls with thermal insulation 25 and heating elements 40 therein, as shown in FIG. 3. The first compartment 21 forms an enclosure for the plurality of golf balls 60 (preferably at least four golf balls 60A-60D) contained therein insulating the golf balls from outside temperature and heating the golf balls to a desired temperature for obtaining maximum distance of travel of each of the golf balls upon striking each of the golf balls with a golf club. At least one opening 26 having a zipper 22 admits golf balls 60 into the first compartment and allows heated golf balls 60 to be removed from the first compartment 21.

A second compartment 23 comprises a pocket on the outside of and in proximity to the first compartment 21. At least one battery pack 30 is housed in the second compartment for powering the heating elements 40.

The insulated heated container device 10 for warming golf balls 60 preferably comprises a padded bag having the first compartment 21 formed by two padded insulated front and back walls containing heating elements 40. A third wall attached to the outside of the first compartment to form the second compartment 23 between the third wall and the front wall of the first compartment.

A zipper 22 in the top insulated wall and at least partially down the insulated side walls is preferably used for opening and closing the closeable opening 29 in the first compartment.

The device further comprising a closable flap 24 over the second compartment 23, which preferably utilizes mating hook and loop fastener components 27 and 28 for removably interconnecting the closable flap 24 to the outside of the second compartment 23.

An electrical plug 41 from the heating coils 40 plugs into a battery plug receptacle 31 to form an electrical connection between the battery 30 and the heating elements 40 for powering the heating elements to warm the plurality of golf balls 60 to the desired temperature, thereby providing an insulated heated container device 10 for warming golf balls 60.

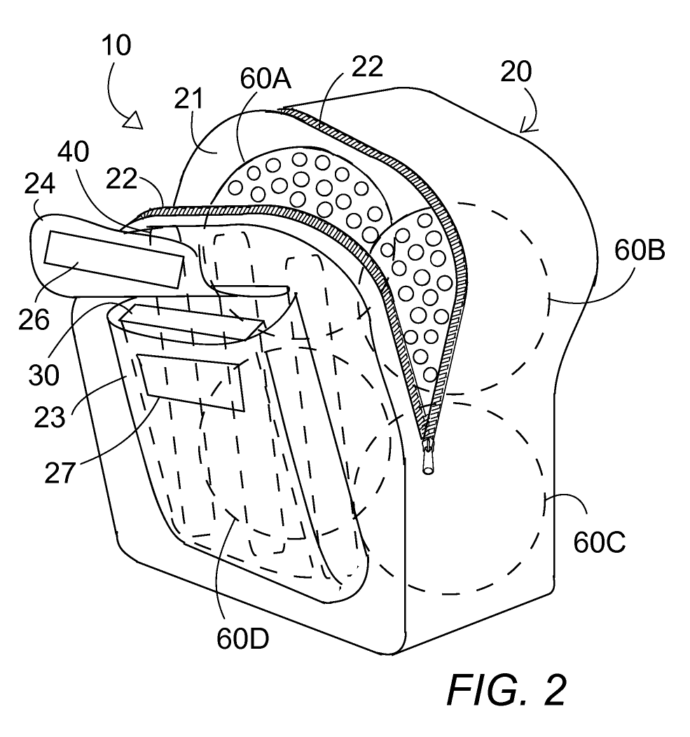

In FIG. 2, the first compartment 21 houses at least four golf balls 60A-60D therein which are removable and replaceable within the compartment in an organized array so that the warmest golf ball 60A may be removed to be used first from a first position in the array while the remaining cooler golf balls are heated. By numbering the positions and rotating the golf balls in the present invention, the warmest golf ball 60A is used first and the second warmest golf ball 60D is used second. After a golf ball 60A is used, it is placed in the ball warmer bag in the 60B position and is eventually rotated back to the 60A position so it has the longest time to be heated before being reused again.

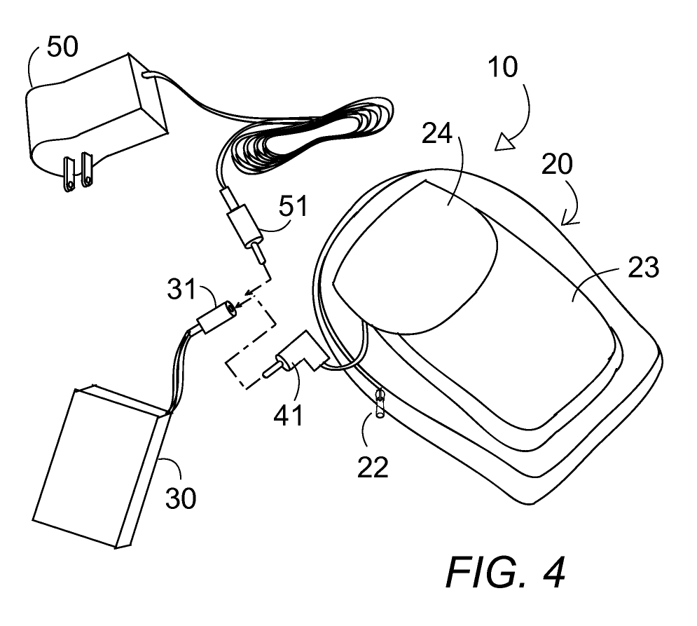

In FIG. 4, the battery pack 30 is removably attached to the heating elements by plug receptacle 31 so that the battery 30 is removable from the second compartment 23 for replacement of the battery or remote charging of the battery 30 by using a battery charger transformer plug 50 plugged into a wall outlet with a charging plug 51 plugged into the battery plug receptacle 31.

The present invention can heat the golf balls to the desired temperature even when external temperatures are as low as between 36° Fahrenheit for at least 5 hours.

The golf ball carrying and heating bag size of the present invention is preferably about 5″×3.5″×2.5″ wide and has a VELCRO® closable flap 24 to cover the outside compartment 23.

In use, the battery 30 or batteries use heating elements 40 which are insulated by insulation layers 25 to warm the golf balls 60, thus making it easier for the golfer to hit the balls much further than hitting cold golf balls. Testing results show that golf balls heated to an internal temperature of between 100° to 120° will provide much longer driving distances compared with balls measured at lower temperatures. The golf ball warmer of the present invention will provide extra distance, increase confidence and improve scores. The big difference is that it is easier to score when the drives are approximately 15% closer to the green. Instead of hitting a longer iron for an approach shot, a golfer will be hitting a shorter iron to the green, thus playing and scoring better.

It is understood that the preceding description is given merely by way of illustration and not in limitation of the invention and that various modifications may be made thereto without departing from the spirit of the invention as claimed.

What is claimed is:

1. An insulated heated container device for warming golf balls, the device comprising:
a first compartment sufficiently large for containing a plurality of golf balls therein, the first compartment comprising thermally insulated walls with heating elements therein to form an enclosure for the plurality of golf balls contained therein insulating the golf balls from outside temperature and heating the golf balls to a desired temperature for obtaining maximum distance of travel of each of the golf balls upon striking each of the golf balls with a golf club, and at least one closable opening to admit golf balls into the first compartment and remove golf balls from the first compartment;
a second compartment in proximity to the first compartment, the second compartment housing at least one battery;
an electrical connection between the at least one battery and the heating elements for powering the heating elements to warm the plurality of golf balls to the desired temperature, thereby providing an insulated heated container device for warming golf balls.

2. The device of claim 1 wherein the first compartment houses at least four golf balls therein which are removable and replaceable within the compartment in an organized array so that a warmed golf ball may be removed for use from a first position in the array and a cooled golf ball may be installed in a second position in the array to advance the positions of the other golf balls contained therein so that a fully heated golf ball moves into the first position in the array fully warmed and ready for play.

3. The device of claim 1 wherein the at least one battery is removably attached to the heating elements so that the at least one battery is removable from the second compartment for replacement of the at least one battery.

4. The device of claim 1 wherein the at least one battery is removably attached to the heating elements so that the at least one battery is removable from the second compartment for recharging of the at least one battery.

5. The device of claim 1 further comprising a plug receptacle communicating with the at least one battery so that the at least one battery is connectable through the plug receptacle to a means for charging the at least one battery.

6. The device of claim 1 further comprising a zipper for opening and closing the closeable opening in the first compartment.

7. The device of claim 1 further comprising a closable flap over the at least one of the compartments.

8. The device of claim 7 further comprising mating hook and loop fastener components removably interconnecting the closable flap to the insulated heated container device.

9. The device of claim 1 wherein the insulated heated container device for warming golf balls comprises a padded bag having the first compartment formed by two padded insulated walls containing heating elements and a third wall attached to the outside of the first compartment to form the second compartment therebetween.

10. The device of claim 1 wherein the thermally insulated walls and battery pack powered heating elements can heat preferably four golf balls to the desired temperature when the outside temperature is as low as 36° Fahrenheit for up to 5 hours.
